(19) United States
(12) Patent Application Publication
(10) Pub. No.: US 2023/0167947 A1
(43) Pub. Date: Jun. 1, 2023

(54) CRYOGENIC STORAGE SYSTEM

(71) Applicant: MAGNA STEYR Fahrzeugtechnik GmbH & Co KG, Graz (AT)

(72) Inventors: Daniel HAMMER, Graz (AT); Martin STUBENRAUCH, Wundschuh (AT)

(73) Assignee: MAGNA STEYR Fahrzeugtechnik GmbH & Co KG, Graz (AT)

(21) Appl. No.: 18/058,787

(22) Filed: Nov. 25, 2022

(30) Foreign Application Priority Data
Dec. 1, 2021 (DE) 102021213644.3

(51) Int. Cl. F17C 7/04

(52) U.S. Cl. CPC F17C 7/04; F17C 2223/0161; F17C 2205/0352; F17C 2205/0323; F17C 2227/0302; F17C 2203/0391; F17C 2221/012

(57) ABSTRACT

A storage system for storing a cryogenic medium. The storage system includes a storage container operable to receive the cryogenic medium; a first removal line forming a fluid-conducting connection from an interior of the storage container to a first consumer connection for connecting a consumer device that uses the cryogenic medium; a first controllable line shut-off valve arranged in the first removal line; a first heat exchanger arranged in the first removal line; a second removal line, redundant to the first removal line, forming a second fluid-conducting connection from the interior of the storage container to a second consumer connection for connecting the consumer device; a second controllable line shut-off valve, redundant to the first controllable line shut-off valve, arranged in the second removal line; and a second heat exchanger, redundant to the first heat exchanger, arranged in the second removal line.

### CROSS-REFERENCE TO RELATED APPLICATIONS

The present application claims priority under 35 U.S.C. § 119 to German Patent Publication No. DE 10 2021 213 644.3 (filed on Dec. 1, 2021), which is hereby incorporated by reference in its complete entirety.

### TECHNICAL FIELD

One or more embodiments of the present disclosure relates to a storage system for storing a cryogenic medium, in particular, for storing hydrogen. One or more embodiments of the present disclosure further relates to a system comprising such a storage system and a consumer device for the medium received in the storage container of the storage system.

### BACKGROUND

It is known that cryogenic media, i.e. low-temperature and at least partially liquid media, such as hydrogen or helium, can be stored in a storage container in order to transport energy, for example for the propulsion of a vehicle, a ship, an aircraft or a rocket. The medium is generally partially in liquid form and also partially in gaseous form in the storage container.

In the known cryogenic storage systems, a wide variety of lines are arranged as the connection between the internal tank and the external surroundings of the storage system. These lines are required for different purposes, such as for example for conducting cryogenic liquid medium from the internal tank to the heat exchanger or evaporator and to a consumer device. Occasionally, such storage systems also have a pressure build-up system and, depending on the type, an open or closed system. A pressure build-up system can compensate for the drop in pressure which occurs with the removal of gaseous or liquid hydrogen, for example. This is generally ensured either by an internal tank heat exchanger (closed pipeline system) or by direct evaporation (open system).

In the known cryogenic storage systems, there is a removal line which represents a connection from the interior of the tank to a consumer device. In the event of a fault in a component in this removal line, generally it leads to a breakdown (shutdown) of the system, since the medium is no longer able to be supplied from the internal tank to the consumer device.

### SUMMARY

One or more embodiments are to specify a storage system for storing a cryogenic medium and a device comprising such a storage system and a consumer device for the medium received in the storage container of the storage system, which is fault-tolerant, wherein in particular in the case of a breakdown of an individual component of a removal line it should not lead to a total breakdown in the supply to a consumer device from the storage system.

In accordance with one or more embodiments, a storage system for storing a cryogenic medium, in particular for storing hydrogen, comprises: a storage container for receiving the medium; a first removal line forming a fluid-conducting connection from an interior of the storage container to a consumer connection for connecting a consumer device; at least a first controllable line shut-off valve and a first heat exchanger are arranged in the first removal line; a second removal line, which is different from the first removal line, forming a fluid-conducting connection from the interior of the storage container to a consumer connection for connecting the same consumer device; at least a second controllable line shut-off valve arranged in the second removal line; and a first heat exchanger arranged in the second removal line.

In accordance with one or more embodiments, the removal line of a storage system comprises a controllable line shut-off valve in order to control the removal of the medium from the storage container into the removal line. The removal line further comprises a first heat exchanger arranged downstream of the line shut-off valve, and which serves to control the temperature of the removed medium such as hydrogen to the desired removal conditions. In particular, the first heat exchanger is operable to heat up the removed medium and also, should liquid medium be removed, to evaporate the removed medium. In accordance with one or more embodiments, such a removal line from the internal container to a consumer device is configured to be redundant twice, or even more frequently.

Thus, according to the disclosure there is a first removal line and a second removal line which is different therefrom, each of the removal lines having similar components so that the removal lines can undertake the same function. In particular, both the first removal line and the second removal line respectively have a line shut-off valve which is associated therewith in order to control the inflow into the removal line, as well as an assigned heat exchanger in order to control the temperature of the medium to the desired removal conditions.

In conventional cryogenic storage systems, the quantity and the type of pipework is limited to a minimum for thermodynamic reasons. Conversely, in accordance with the disclosure, a greater number of components is used. Thus, individual faults of the components no longer lead to a total breakdown (shutdown) of the system, since the components and the connection to the consumer device are not simply connected to the internal tank but designed to be redundant.

Both the first and second removal line can be designed, for example, to remove gaseous medium from the storage container or both can be designed to remove liquid medium from the storage container. For example, the first removal line can be designed to remove gaseous medium from the storage container and the second removal line can be designed to remove liquid medium from the storage container.

In accordance with one or more embodiments, the consumer connection of the first removal line and the consumer connection of the second removal line are combined together to form a common connection. In an alternative embodiment, the two consumer connections are not combined together to form a common connection. Thus, the two consumer connections can form a common connection or two separate connections to the same consumer device.

In accordance with one or more embodiments, the first removal line additionally has a third controllable line shut-off valve directly upstream of the consumer connection, and the second removal line additionally has a third controllable line shut-off valve directly upstream of the consumer connection. The third controllable line shut-off valve can serve as a shut-off device upstream of the connected consumer device.

In accordance with one or more embodiments, the first removal line additionally has an internal tank heat exchanger downstream of the first heat exchanger and the second removal line additionally has a further internal tank heat exchanger downstream of the further first heat exchanger. The internal tank heat exchanger in each removal line serves to control or to regulate the pressure in the interior of the storage container by means of the medium which has been heated up and removed.

In accordance with one or more embodiments, the first removal line additionally has a second heat exchanger downstream of the internal tank heat exchanger and the second removal line additionally has a further second heat exchanger downstream of the further internal tank heat exchanger. After the transmission of heat by the internal tank heat exchanger of the respective removal line, the desired removal conditions for the medium can also be ensured by the second heat exchangers.

In accordance with one or more embodiments, the first removal line additionally has a flow control valve downstream of the first controllable line shut-off valve and upstream of the internal tank heat exchanger, and the second removal line additionally has a further flow control valve downstream of the second controllable line shut-off valve and upstream of the further internal tank heat exchanger. Only a part of the medium in the storage containers, which has been removed and heated up, can be selectively conducted back to the respective internal tank heat exchanger via the flow control valves.

In accordance with one or more embodiments, generally in the storage system all of the components of the first removal line as far as the consumer connection, such as lines, heat exchangers and valves, can also be present as redundant components in the second removal line and are arranged in the same sequence.

In accordance with one or more embodiments, the storage container is configured to be double-walled with an insulating vacuum space between the two walls of the storage container. According to one embodiment, the first and the second controllable line shut-off valve and/or the two first heat exchangers of the first and second removal line, particularly preferably also the second heat exchangers of the first and second removal line, are arranged in the vacuum space.

In accordance with one or more embodiments, the first and second controllable line shut-off valve and/or the first heat exchangers of the first and second removal line are arranged outside an external container of the storage container, wherein at least parts of the lines are configured outside an external container of the storage container as vacuum-insulated lines.

The storage container can also comprise at least one secondary vacuum space or space with an inert gas atmosphere—in particular additionally to a vacuum space between the inner wall and outer wall of the container, wherein the first controllable line shut-off valve and the second controllable line shut-off valve and/or the first heat exchangers of the first and second removal line, and preferably all of the components of the first and second removal line, are arranged in the secondary vacuum space or space with an inert gas atmosphere. Particularly preferably, the components for the first removal line and the second removal line are arranged in each case in a separate secondary vacuum region or space with an inert gas atmosphere, i.e. in each case assigned to the first or second removal line, so that each removal line has its own secondary vacuum space or space with an inert gas atmosphere.

In accordance with one or more embodiments a device comprises a storage system as set forth and described hereinabove, and a consumer device for the medium received in the storage container, wherein the consumer connection of the first removal line and the consumer connection of the second removal line are connected to the consumer device. In this case, the consumer connection of the first removal line and the consumer connection of the second removal line can be combined together to form a common connection to the consumer device, or alternatively cannot be combined together to form a common connection to the consumer device, i.e. can form two separate connections to the consumer device.

### DRAWINGS

One or more embodiments will be illustrated by way of example in the drawings and explained in the description hereinbelow.

FIG. 1 illustrates a schematic view of a storage system, in accordance with one or more embodiments.

FIG. 2 illustrates a schematic view of a storage system, in accordance with one or more embodiments.

FIG. 3 illustrates a schematic view of a storage system, in accordance with one or more embodiments.

FIG. 4 illustrates a schematic view of a storage system, in accordance with one or more embodiments.

FIG. 5 illustrates a schematic view of a storage system, in accordance with one or more embodiments.

FIG. 6 illustrates a schematic view of a storage system, in accordance with one or more embodiments.

FIG. 7 illustrates a schematic view of a storage system, in accordance with one or more embodiments.

FIG. 8 illustrates a schematic view of a storage system, in accordance with one or more embodiments.

FIG. 9 illustrates a schematic view of a storage system, in accordance with one or more embodiments.

FIG. 10 illustrates a schematic view of a storage system, in accordance with one or more embodiments.

### DESCRIPTION

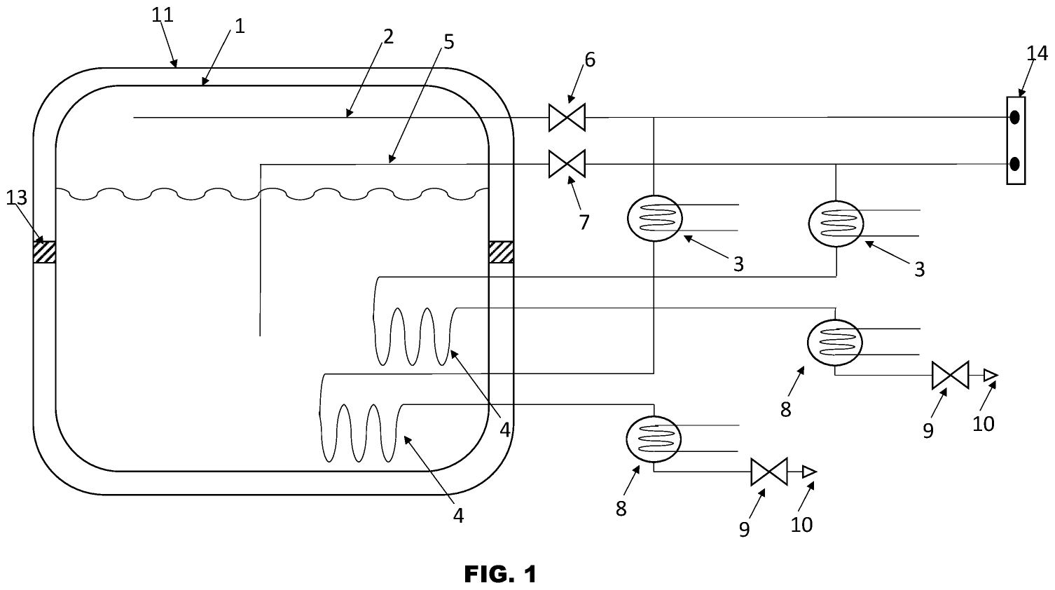

A storage system according to the disclosure for storing a cryogenic medium, in particular for storing hydrogen, is shown in FIG. 1.

The storage system comprises a storage container 1 for receiving the medium. The storage container 1 forms an internal container of a double-walled container which additionally comprises an external container 11. A vacuum is formed between the external container 11 and the internal container, i.e., storage container 1. Suspension elements 13 are additionally arranged in some portions between the external container 11 and the internal container in order to position the two shells of the double-walled container relative to one another.

The cryogenic medium, in particular hydrogen, is located in the lower region of the storage container 1, namely as liquid in the container below the liquid surface, shown in the figure as a wavy line, and in the gaseous state above the wave-shaped liquid surface.

A gas removal line 2 is designed to remove the gaseous medium from the storage container 1, so that the free end of the gas removal line 2 terminates in the storage container 1 above the liquid surface in the vicinity of the top of the storage container 1. The first removal line begins with the gas removal line 2.

A liquid removal line 5 is designed to remove the liquid medium from the storage container 1, so that the free end of the liquid removal line 5 terminates in the storage container 1 below the liquid surface in the vicinity of the bottom of the storage container 1. The second removal line begins with the liquid removal line 5.

The terms “top” and “bottom” refer in this case to the conventional installed position of the storage container, for example in a transport device which travels on the ground, floats in water or flies in the air, wherein in normal operation of the transport device gravitational force acts in the direction of the bottom of the storage container.

A first controllable line shut-off valve 6 is arranged in the gas removal line 2, and a second controllable line shut-off valve 7 is arranged in the liquid removal line 5. Both line shut-off valves are located outside the storage container 1. In FIG. 1 the line shut-off valves are also located outside the external container 11.

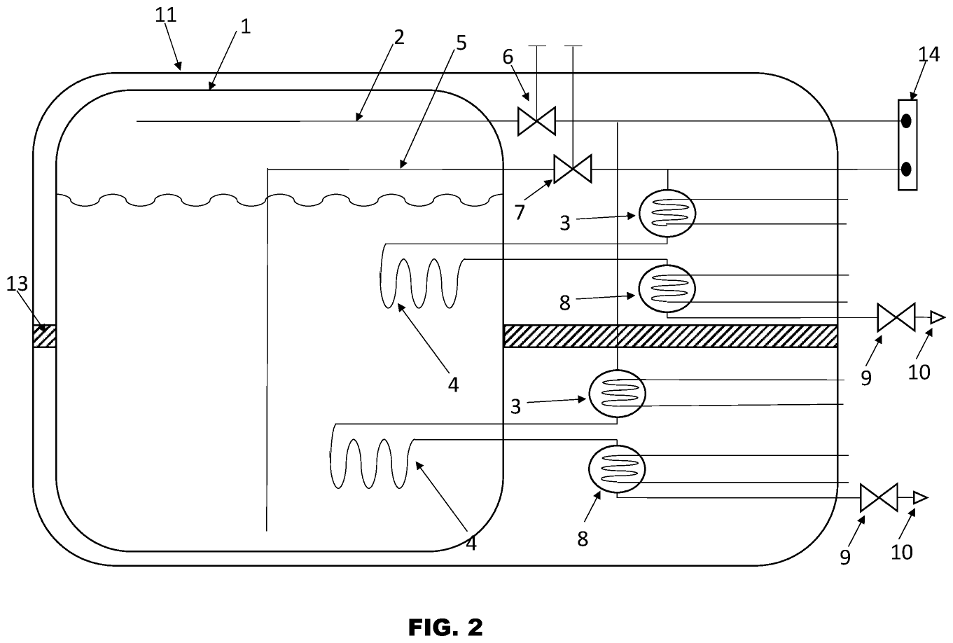

In an alternative embodiment of the storage system, which is shown in FIG. 2, the two line shut-off valves 6, 7 are arranged inside the external container 11, i.e. between the internal container, storage container 1, and the external container 11 of the double-walled storage container, namely in the vacuum space.

The line shut-off valves are controllable by a control device which can also be arranged in the vacuum space (FIG. 2) or outside the entire container (FIG. 1). In this case, the flow through the line shut-off valves is preferably not only able to be interrupted or opened up but also reduced.

A refueling of the storage container 1 can also take place from a refueling device 14 via the gas removal line 2 and/or the liquid removal line 5, preferably also via the first line shut-off valve 6 and/or the second line shut-off valve 7.

The gas removal line 2 and the liquid removal line 5 also run downstream of the two line shut-off valves 6, 7 as two separate lines, in each case with their own components assigned thereto and thus form two separate removal lines.

The gas removal line 2 and the liquid removal line 5 are connected in terms of flow as separate removal lines to the respectively assigned first heat exchanger 3 arranged outside the storage container 1, for example between the storage container 1 and the external container 11 of the double-walled storage container (FIG. 2), for heating up the removed medium.

In each case an internal tank heat exchanger 4 is arranged downstream of the first heat exchanger 3 inside the storage container 1, for heating up the liquid medium in the storage container 1, the heated-up medium removed from the storage container 1 flowing through said internal tank heat exchanger. The liquid medium is partially heated up and evaporated in the storage container 1 by being heated up on the internal tank heat exchanger 4.

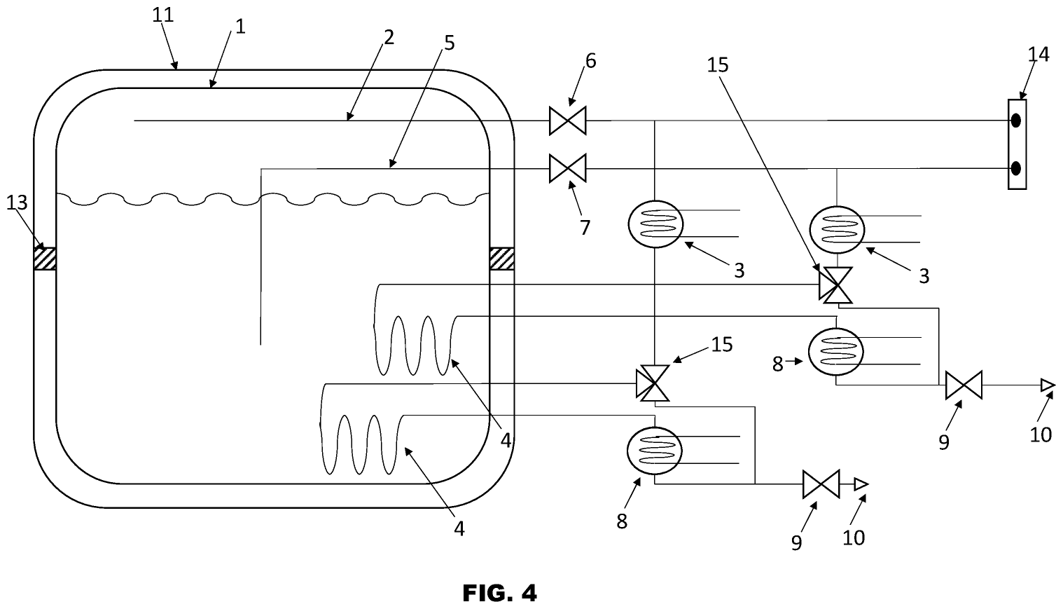

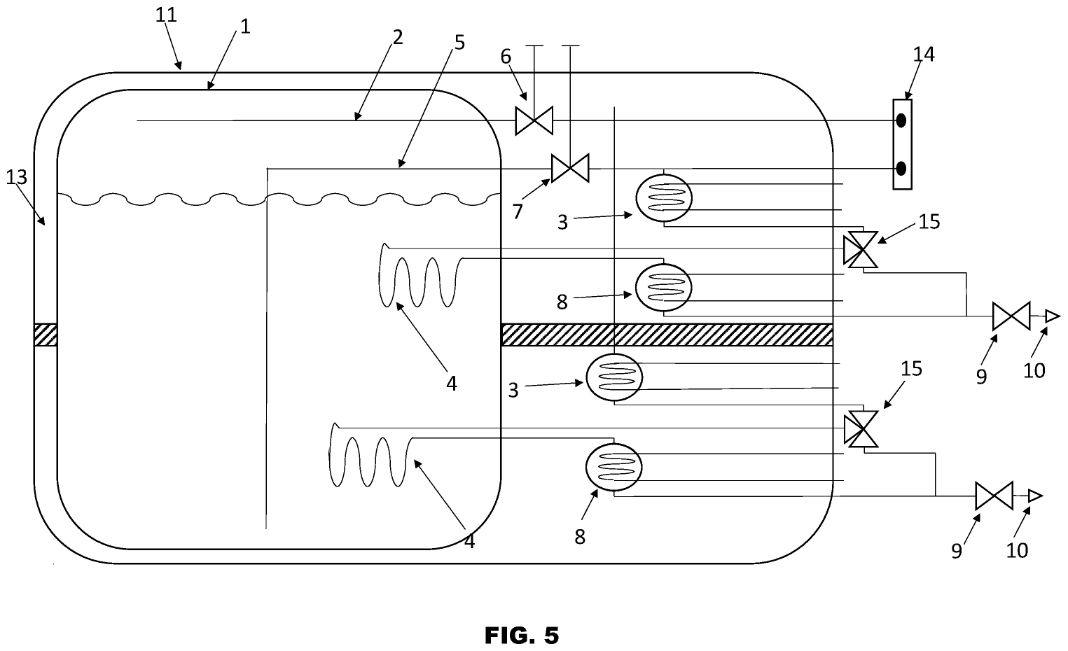

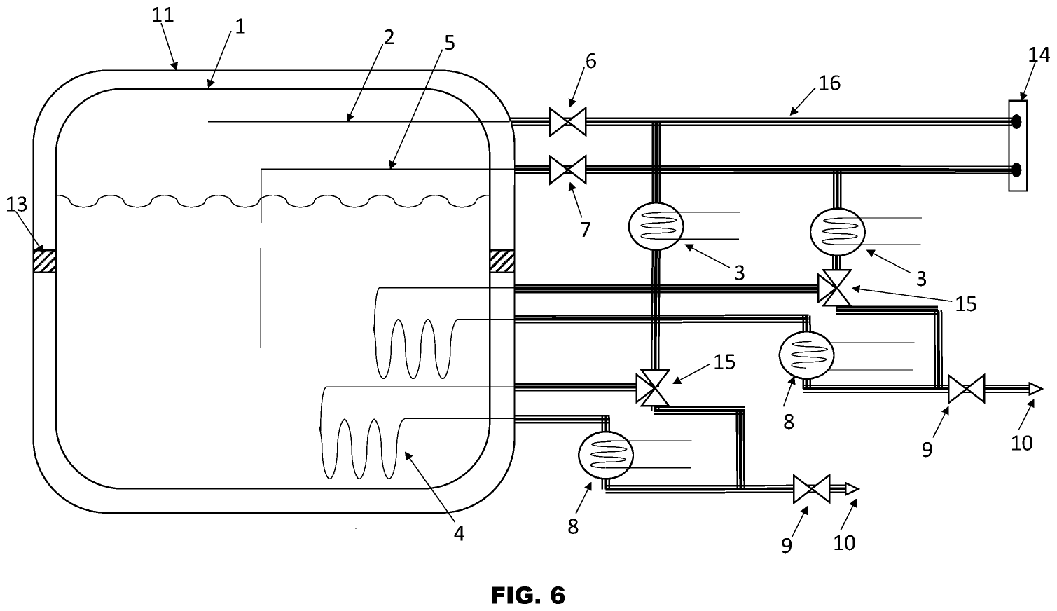

A controllable three-way valve, i.e. a flow control valve 15, is not arranged in the gas removal line 2 and in the liquid removal line 5 of the embodiment according to FIG. 1 to FIG. 3, so that all of the medium removed by the gas removal line 2 and/or by the liquid removal line 5 and heated up by the first heat exchanger 3 passes to the internal tank heat exchanger 4. In the embodiments according to FIG. 4 to FIG. 6 a flow control valve 15 is arranged in each removal line, so that merely a part of the medium removed by the gas removal line 2 and/or by the liquid removal line 5 and heated up by the first heat exchanger 3 selectively passes to the respective internal tank heat exchanger 4.

In each case, a second heat exchanger 8 is arranged downstream of the respective internal tank heat exchanger 4 and outside the storage container 1, outside (FIG. 1) or inside (FIG. 2) the external container 11 of the double-walled container, for heating up the medium in the first removal line and in the second removal line.

The medium flowing via the first and/or second removal line is supplied downstream of the respective internal tank heat exchanger 4 to the same consumer device via one respective consumer connection 10, in particular a fuel cell as a consumer device. In each removal line, a third line shut-off valve 9 is arranged between the second heat exchanger 8 and the consumer device 10.

The embodiment of FIG. 2 differs from FIG. 1 in that control-relevant components of both removal lines of the storage system, such as the first heat exchangers 3, the second heat exchangers 8, the first line shut-off valve 6 and the second line shut-off valve 8, are arranged inside the external container 11 and not outside the external container 11 as in FIG. 1, and thus in the intermediate space of the double-walled container which forms a vacuum space.

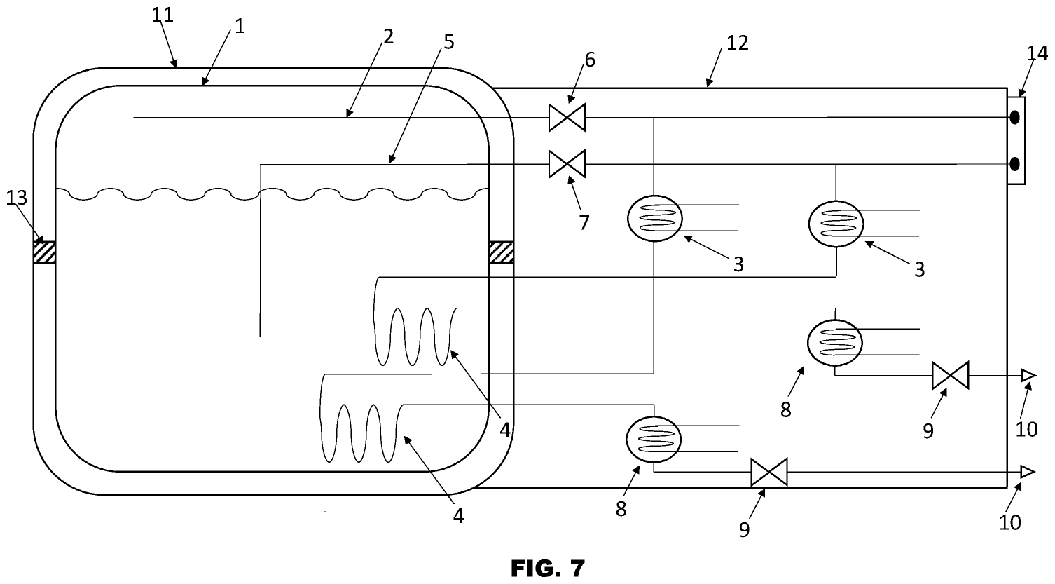

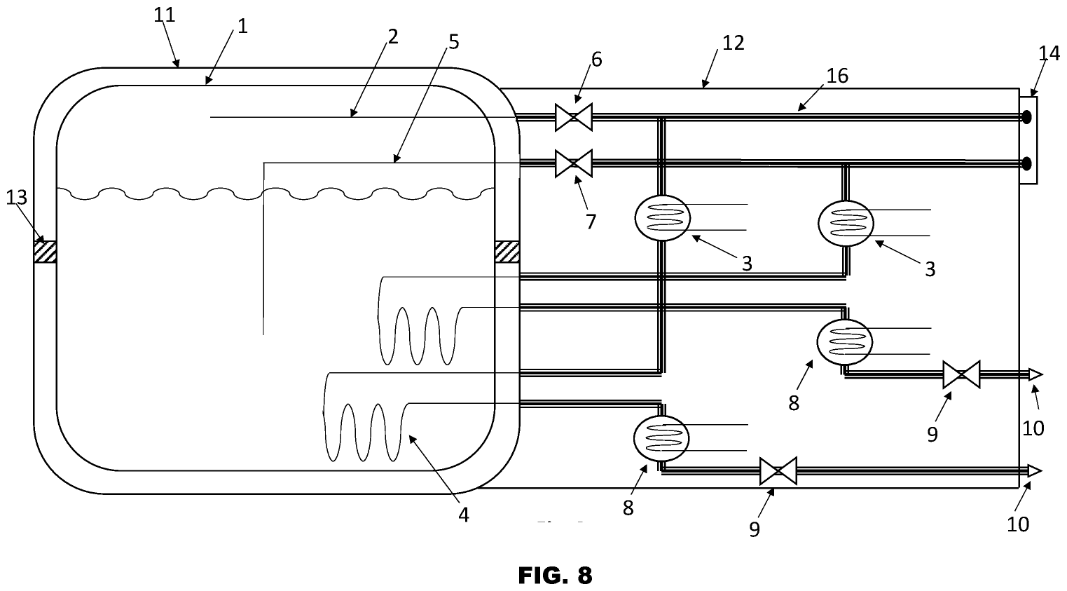

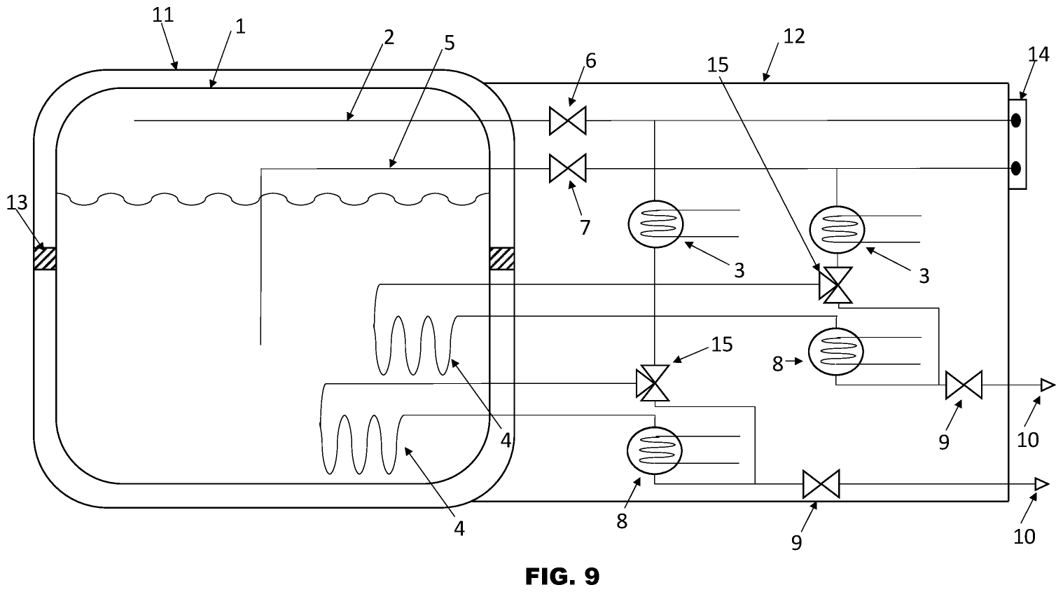

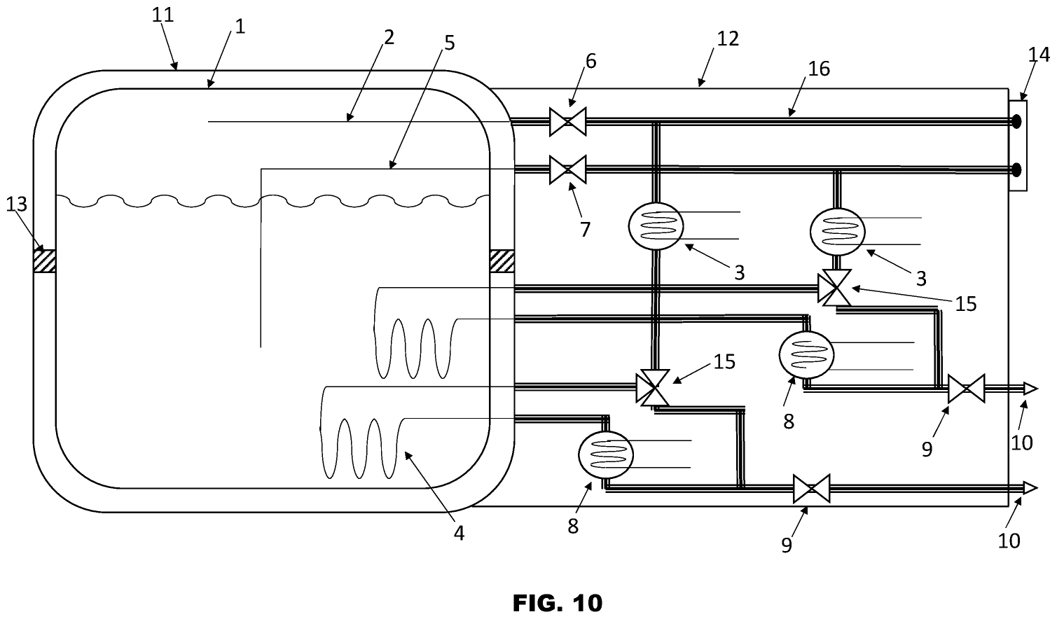

In this case, two separate regions of the vacuum space can be used exclusively for the heat exchangers 3, 8 of the first removal line and for the heat exchangers 3, 8 of the second removal line. As a result, faults in a removal line can be detected in a simpler manner and assigned to the relevant removal line. The two regions of the vacuum space can be separated by the suspension elements 13. The separation, however, can also be implemented by at least one additional secondary vacuum space 12. It is also possible for all of the components of the two removal lines to be fitted in an additional secondary vacuum space 12 so as not to destroy the primary vacuum located between the storage container 1 and the external container 11, in the case of a fault, and thus empty the entire contents of the storage container 1 via the safety device (FIG. 7 to FIG. 10). Instead of the secondary vacuum 12, an inert gas atmosphere (for example helium, nitrogen, argon) can also be produced in the space 12.

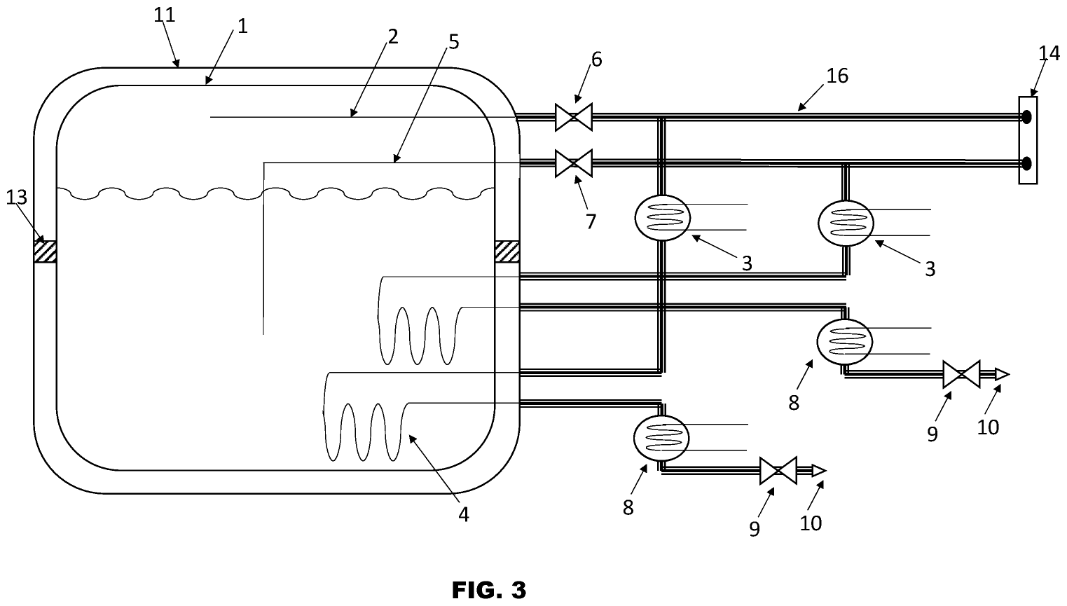

In the embodiment of FIG. 3, the lines running outside the storage container are configured between the components of the respective removal line as vacuum-insulated lines 16.

Thus, as a whole the cryogenic valves 6 and 7 and the heat exchangers 3 and 8 and the shut-off devices 9 can be positioned outside the tank system (FIG. 1). For example, in cryogenic storage systems where this cannot be easily implemented technically, due to the very low temperatures and thus the ice formation associated therewith or other safety-relevant conditions, these components can be placed inside the vacuum region (FIG. 2) and only those components which are required for the shut-off can be placed outside. As an alternative, for example so as to be able to utilize the installation space more effectively, since no components have to be placed between the internal tank 1 and the external tank 11, the cryogenically-conducting lines and components can be connected by means of vacuum-insulated lines 16 in order to minimize or to reduce an occurrence of cryogenic temperatures or other safety-relevant problems (FIG. 3). Preferably, at least vacuum-insulated lines have to be used to the first heat exchangers 3 in order to avoid ice formation or air liquefaction.

As already mentioned, it is possible to conduct the entire removal flow through the internal tank heat exchanger 4 (See FIGS. 1 through 3). This can be undesirable in some applications, however, whereby a further component can be required, namely a flow control valve 15. This flow control valve serves, for example, to conduct a percentage of the controlled mass flow via the internal tank heat exchanger 4, whereby a controlled and thus stabilized working area can be set (See, FIGS. 4 through 6).

For mobile applications, in order to be able to ensure a removal of the medium, even in the case of individual faults, according to the disclosure a redundancy is incorporated in the storage system. In this case, however, a doubling of the cryogenic valves, i.e. the first and second controllable line shut-off valve 6 and 7 is not required. By means of this measure, it is possible to produce a system which can compensate for breakdowns of individual components and thus can also prevent the loss of functionality of the storage system. In this case, there are two removal lines which can differ in the type of removal (gas, liquid). Due to the redundant design with two removal lines which are not connected together, in the case of a breakdown or leakages of a component in one removal line, the other removal line can respectively undertake the full functionality of the other. In particular, in aviation, shipping and in the automotive sector, such a scenario in which an individual breakdown or a single fault leads to the shutdown of the entire tank system, is not desirable. A further advantage is that substantially more components are not required, in spite of the redundant design.

A removal line can be provided and correspondingly designed for the removal of liquid cryogenic medium. The second removal line can represent the possibility of removing gaseous medium. As a result, in spite of the novel type of pipework, there is the possibility for the storage system to change between the type of removal, as can be desirable for an improved performance of the tank system.

In the case of an individual fault, in order to identify the fault and to permit the type of removal to be changed, different methods can be implemented for monitoring the system.

One method comprises fitting the components (all of the components which are required for the removal, following the cryogenic valves) in a larger vacuum region (secondary vacuum) 12, for example on the front face or along the tank axis (FIGS. 7 through 10). As a result, leakages to the outside can be rapidly identified and the removal variant can be changed before the system suffers a breakdown. In this case, a further variant is advantageous when a separate secondary vacuum region 12 is designed in each case for the first and second removal line. It should also be mentioned here that, instead of the secondary vacuum, an inert gas atmosphere (for example helium, nitrogen, argon) can also be produced in the space 12. For example, when this installation space cannot be used, in a second method the removal lines can be monitored by vacuum-insulated pipelines 16 in order to identify breakdowns and leakages if required.

Accordingly, the components for the secondary system have to be differently designed or respectively installed for a worst case scenario for both removal lines. If required, this also means that the storage system can have two pressure build-up systems fitted, since each removal line per se should have the option to regulate the pressure of the tank, since this component could also have a fault.

### LIST OF REFERENCE SYMBOLS

1 Storage container
2 Gas removal line
3 First heat exchanger
4 First internal tank heat exchanger
5 Liquid removal line
6 First controllable line shut-off valve
7 Second controllable line shut-off valve
8 Second heat exchanger
9 Third controllable line shut-off valve
10 Consumer connection(s)
11 External container
12 Secondary vacuum space/space for inert gas atmosphere
13 Suspension element
14 Refuelling device
15 Flow control valve
16 Vacuum-insulated line

What is claimed is:

1. A storage system for storing a cryogenic medium, the storage system comprising:
a storage container operable to receive the cryogenic medium;
a first removal line forming a fluid-conducting connection from an interior of the storage container to a first consumer connection for connecting a consumer device that uses the cryogenic medium;
a first controllable line shut-off valve arranged in the first removal line;
a first heat exchanger arranged in the first removal line;
a second removal line, different from the first removal line, forming a second fluid-conducting connection from the interior of the storage container to a second consumer connection for connecting the consumer device;
a second controllable line shut-off valve arranged in the second removal line; and
a second heat exchanger arranged in the second removal line.

2. The storage system of claim 1, wherein the first consumer connection of the first removal line and the second consumer connection of the second removal line are combined together to form a common connection.

3. The storage system of claim 1, further comprising:
a third controllable line shut-off valve arranged in the first removal line directly upstream of the first consumer connection, and
a fourth controllable line shut-off valve arranged in the second removal line additionally directly upstream of the second consumer connection.

4. The storage system of claim 1, further comprising:
a first internal tank heat exchanger arranged in the first removal line downstream of the first heat exchanger and in the storage container; and
a second internal tank heat exchanger arranged in the second removal line downstream of the first heat exchanger and in the storage container.

5. The storage system of claim 4, further comprising:
a first flow control valve in the first removal line downstream of the first controllable line shut-off valve and upstream of the first internal tank heat exchanger; and
a second flow control valve in the second removal line downstream of the second controllable line shut-off valve and upstream of the second internal tank heat exchanger.

6. The storage system of claim 4, further comprising:
a third heat exchanger arranged in the first removal line downstream of the first internal tank heat exchanger and external to the storage container; and
a fourth heat exchanger arranged in the second removal line downstream of the second internal tank heat exchanger and external to the storage container.

7. The storage system of claim 4, wherein the storage container has a double-wall structural configuration defining an insulating vacuum space between the walls of the storage container.

8. The storage system of claim 7, wherein:
the first controllable line shut-off valve and the second controllable line shut-off valve are arranged in the vacuum space,
the first heat exchanger and the second heat exchanger are arranged in the vacuum space, and
the third heat exchanger and the fourth heat exchanger are arranged in the vacuum space.

9. The storage system of claim 7, wherein the first controllable line shut-off valve and the second controllable line shut-off valve are arranged in the vacuum space.

10. The storage system of claim 7, wherein the first heat exchanger and the second heat exchanger are arranged in the vacuum space.

11. The storage system of claim 7, wherein the third heat exchanger and the fourth heat exchanger are arranged in the vacuum space.

12. The storage system of claim 7, wherein:
the first heat exchanger is arranged external to the storage container, and
the second heat exchanger is arranged external to the storage container.

13. The storage system of claim 7, wherein:
the first controllable line shut-off valve is arranged external to the storage container, and
the second controllable line shut-off valve is arranged external to the storage container.

14. The storage system of claim 7, wherein:
portions of the first removal line arranged external to the storage container are vacuum-insulated, and
portions of the second removal line arranged external to the storage container are vacuum-insulated.

15. The storage system of claim 1, wherein the storage container comprises at least one secondary vacuum space with an inert gas atmosphere.

16. The storage system of claim 15, wherein the first controllable line shut-off valve and the second controllable line shut-off valve are arranged in the at least one secondary vacuum space.

17. The storage system of claim 15, wherein the first heat exchanger and the second heat exchanger are arranged in the at least one secondary vacuum space.

18. The storage system of claim 1, wherein:
the second removal line is redundant to the first removal line,
the second controllable line shut-off valve is redundant to the first controllable line shut-off valve, and
the second heat exchanger is redundant to the first heat exchanger.

19. A storage system for storing a cryogenic medium, the storage system comprising:
a storage container operable to receive the cryogenic medium;
a first removal line forming a fluid-conducting connection from an interior of the storage container to a first consumer connection for connecting a consumer device that uses the cryogenic medium;
a first controllable line shut-off valve arranged in the first removal line;
a first heat exchanger arranged in the first removal line;
a second removal line, redundant to the first removal line, forming a second fluid-conducting connection from the interior of the storage container to a second consumer connection for connecting the consumer device;
a second controllable line shut-off valve, redundant to the first controllable line shut-off valve, arranged in the second removal line; and
a second heat exchanger, redundant to the first heat exchanger, arranged in the second removal line.

20. A system, comprising:
the storage system of claim 19; and
a consumer device that uses the cryogenic medium.
